(19) United States
(12) Patent Application Publication
(10) Pub. No.: US 2006/0064366 A1
(43) Pub. Date: Mar. 23, 2006

(54) Method and cash trust for financing and operating a business project

(76) Inventor: Steven E. Smith, Brick, NJ (US)

Correspondence Address: AMSTER, ROTHSTEIN & EBENSTEIN LLP, 90 PARK AVENUE, NEW YORK, NY, 10016, US

(21) Appl. No.: 10/945,815

(22) Filed: Sep. 21, 2004

(51) Int. Cl. G06Q 40/00

(52) U.S. Cl. 705/35

(57) ABSTRACT

A method and financial arrangement for financing (or refinancing) and operating a business project are provided. They are designed to better allocate the risks inherent in setting up and operating the business project and optimize the benefits of the project for all of the involved parties—lenders, sponsors, investors, operators and consumers and/or end users of the project. This novel method and financial arrangement provide additional security for lenders and investors of the project, while, at the same time, providing benefits and incentives to consumers and/or end users of the project. As an illustrative example, an embodiment of the present invention is applied to a power plant project. Among many potential benefits, the present invention may provide a solution for overcoming the current disarray in the power industry.

### FIELD OF THE INVENTION

The present invention relates generally to a method and financial arrangement for financing and operating a business project. In particular, the present invention relates to a method and financial arrangement that optimizes the benefits for the business project by strengthening the credit quality of the project and better allocating the risks inherent in setting up and operating the business project. Additionally, the present invention encourages prospective consumers and/or end users to invest and/or participate in the business project and to remain as long-term consumers and/or end users.

### BACKGROUND OF THE INVENTION

Large, capital-intensive business projects, which usually have significant start-up and operating costs, are often financed under a non-recourse or limited recourse financing structure called “project finance.” Examples include electrical generation (e.g., conventional and nuclear power) and electrical transmission projects, water supply and waste water treatment projects, telecommunication projects, material resource projects (e.g., coal, oil, natural gas) and transportation projects (e.g., airports, tunnels, bridges, highways, railroads), to name a few. Recent examples of project financings include the Coso Geothermal Project in California, the development of a major oil field off the coast of Newfoundland by the Hibernia Oil Field Partners, and the Trans Alaska Pipeline System Project. These projects are typically highly leveraged and financed by multiple lenders (often forming syndicates on a project-by-project basis) and equity investors. One of the objectives of project finance is to appropriately allocate the risks and rewards of the project among the various parties on an agreed basis.

Project finance is a form of asset-backed lending. In project finance, the creditworthiness of a project is based on projected revenues from the operation of the project, as estimated by, for example, independent market studies. Collateral for such non-recourse debt typically includes all of the assets of the project, including revenue-producing contracts. Since collateral is typically limited to debt service payments based on the project's prospective cash flow from operations, and does not typically include the assets of the sponsors of the project, project finance lenders commonly require various security mechanisms to secure funds for debt service in the event of pending default. One such security mechanism is an escrow account (the “Cash Trap Escrow Account”) required to be funded by the project under certain adverse circumstances, as explained below.

A quantitative measure used by lenders to determine or predict whether the project's prospective net cash flow from operations can support timely debt service payments is known as the debt service coverage ratio (“DSCR”). For any given debt service period, DSCR is defined as the net cash flow available to meet debt service payments divided by the debt service:

$$DSCR = \frac{Net Cash Flow}{Debt Service}$$

Project lenders typically require the project to maintain a predetermined, minimum DSCR during the operation of the project. If the project's DSCR falls below this minimum level, generally a certain portion of the net cash flow from the operation of the project is required to be set aside in a Cash Trap Escrow Account. This account is typically held in trust by a third party (e.g., a collateral agent). Until the project's DSCR rises above the minimum level, all or a portion of the project's net cash flow will be required to be deposited in the Cash Trap Escrow Account.

For example, lenders may require the project to maintain a DSCR of at least 1.3. If the project's DSCR falls below this level, lenders may require the project to set aside all or a portion of the project's net cash flow to fund the Cash Trap Escrow Account, which may be used to pay debt service. If the credit quality of the enterprise improves, funds from the Cash Trap Escrow Account may be returned to the project.

The Cash Trap Escrow Account is thought to provide additional security to project lenders, since, under typical project finance agreement, lenders' recourse in an event of the project's default is limited to the assets of the project. But the Cash Trap Escrow Account is problematic since it strips net cash flow from the project or project sponsor when the DSCR falls below a certain level. As a result, the project's or project sponsor's creditworthiness is further impaired because the project cannot use a portion of its total cash flow at the very time the project most needs cash. Thus, the project or project sponsor is placed in even further financial peril and, in many instances, impairment of the project creditworthiness is accelerated. While this security mechanism is designed to protect lenders in the event of the project's default, it actually may accelerate the project's default by making it difficult, often impossible, for the project to continue operating. Under this conventional financing arrangement, disproportionately large risks are allocated to the project sponsors, particularly in highly leveraged transactions.

Specific examples of prior art financing arrangements are described below in the context of financing electric generation projects. For example, financing the construction and operation of a new power plant or restructuring of an existing power plant typically requires a significant amount of initial capital, which is often provided as non-recourse or limited recourse financing. As discussed below, the prior art methods and financial arrangements for financing a power project have various structural shortcomings.

Traditionally, electricity in the United States has been generated and distributed by utilities, which were monopolies subject to various federal, state and local regulations. The traditional paradigm of regulated utility financing is known as the Utility Model. In this model utilities typically did not use project financing to construct new generating plants. Instead, they generally borrowed money on their balance sheets, which were strong because utilities had (i) captive customer bases, (ii) regulatorily approved tariffs that generally reimbursed them for the costs of providing service to their customers, and (iii) rates of return that were set—in effect guaranteed—by their regulators. Because of the inherent strength of their balance sheets, regulated utilities could finance construction of additional capacity on advantageous borrowing terms. However, since these utilities could pass on to ratepayers the costs of constructing and operating new generating plants, they had little incentive to keep construction and operating costs as low as possible.

In an effort to provide lower cost electricity for consumers, laws were enacted at both the federal and state levels to encourage the growth of unregulated utilities or independent power producers (“IPPs”). The Public Utility Regulatory Policies Act of 1978 (“PURPA”), and the Energy Policy Act of 1992 (“EPA”) fostered the development of various project finance models, particularly in the independent power sector.

Under PURPA, a financing model known as the “Long-Term PPA Model” became widely used in this sector. PURPA designated certain unregulated power generators as Qualifying Facilities (“QFs”) and generally required regulated utilities to enter into long-term power purchase agreements (“PPAs”) with QFs. PURPA also required that prices paid to QFs be based not on the cost of QFs producing power, but rather on the purchasing utilities' “avoided cost”—rates established at the outset of the PPAs which were intended to reflect the cost utilities expected to “avoid” by purchasing QF power (and thus not having to generate their own power or purchase power from alternative sources). Since lenders could look to long-term PPAs as sources of long-term revenue streams for QFs, unregulated power generation facilities with long-term PPAs were generally successful in obtaining non-recourse project financing. In addition, a QF was generally able to bear a higher amount of debt (e.g., debt sometimes as high as 90 percent of total project cost) than it would if the project were financed based on spot market or short-term contract energy sales. Following the enactment of PURPA, the long-term PPA Model flourished in the 1980s.

In the 1990s a new model flourished—the “Merchant Model.” The EPA, designed to further encourage the growth of the unregulated power industry, created a new class of unregulated electric generators called “exempt wholesale generators” (“EWGs”). Many EWGs were “merchant plants,” plants that sell their output on the spot market or pursuant to short-term PPAS. Because of the higher risk associated with project financings for merchant plants, these financings tend not to be highly leveraged (e.g., project debt is often 50% or less of total project cost), and the cost of capital is higher than it is likely to be for a project financed on the Long-Term PPA Model.

As a result of the regulatory uncertainty and market upheaval, traditional project finance lenders are very focused on the risks associated with both the Long-Term PPA Model and the Merchant Model.

Despite the apparent security provided by long-term PPAS, even these contracts have heightened risks in an unstable economic and regulatory environment. For example, offtakers under these contracts may be downgraded, affecting the credit quality of the projects. Offtakers may file for bankruptcy or other similar protection (e.g., reorganization under chapter 11 of the Bankruptcy Code) and attempt to reject long-term above-market contracts. Thus, even in project financings based on long-term PPAs lenders may require an additional security arrangement like the Cash Trap Escrow Account.

The need for the additional security arrangement such as the Cash Trap Escrow Accounts is even greater with respect to financings for merchant plants, which are inherently riskier than plants with long-term contracts. Under current market conditions, many lenders have been forced to take over ownership of the merchant plants which have been unable to meet their debt service obligations. In these circumstances, lenders providing debt for new merchant plants are almost certain to want additional security like the Cash Trap Escrow Account.

As explained above, the current invention benefits a project by, among other things, enhancing its credit quality and risk allocation. A typical profit-cost structure of a product or commodity such as electricity generally involves, among other things, fixed cost, variable cost, wholesale profits and/or retail profits. The fixed cost is associated with the initial capital used in constructing the project facility, such as a power generating facility, and includes debt service payment to lenders. The variable cost is associated with the operational cost to produce the product or commodity, such as the cost of fuel in the power plant context. Wholesale distributors and retailers add multiple layers of profits and contingencies in the chain of supply of a product or a commodity.

FIG. 1 illustrates the market structure of a typical power generation model (the “Private Power Model”), which include the Long-Term PPA Model and the Merchant Model. As shown in FIG. 1, the Private Power Model contains many potential points of inefficiency, including extra profit centers, financial hedges and contingencies. Like the Utility Model, the Private Power Model continues to allocate much of the risk, such as fuel price risk, to the consumer without the commensurate benefit of lower energy prices.

Similar shortcomings exist in projects in industries other than electric generation, especially where in which a significant amount of initial capital is required and non-recourse or limited recourse financing is common. Examples of such projects may include energy exploration and production initiatives, transcontinental oil or gas pipelines, electrical transmission projects, and transportation projects, to name a few.

It is an object of the present invention to provide a method and financial arrangement for financing and operating a business project that strengthens the credit quality of the project, better allocates the risks inherent in the project, and optimizes the benefits for all parties, including consumers and/or end users of the project.

It is another object of the present invention to provide a method and financial arrangement for financing and operating a business project that enhances financial security for project lenders.

It is yet another object of the present invention to provide a method and financial arrangement for financing and operating a business project that enhances financial security for project lenders without relying on the Cash Trap Escrow Account arrangement.

It is yet another object of the present invention to provide a method and financial arrangement for financing and operating a business project that enhances the financial benefits and incentives to consumers and/or end users.

It is yet another object of the present invention to provide a method and financial arrangement for financing and operating a business project that provides greater benefits to consumers and/or end users by eliminating layers of profit and contingencies.

It is yet another object of the present invention to provide a method and financial arrangement for financing and operating a business project with a mechanism to generate savings for consumers and/or end users and to return those savings to the consumers and/or end users or invest those savings for the benefit of consumers and/or end users.

It is yet another object of the present invention to provide a method and financial arrangement for financing and operating a business project which attracts and benefits consumers and/or end users, thereby engendering community support for the business project (which is crucial for an infrastructure business project such as a power plant project).

It is yet another object of the present invention to provide a method and financial arrangement for financing and operating a business project that provides financial incentives to prospective consumers and/or end users to effectively invest and/or participate in the project and to remain as long-term consumers and/or end users.

It is yet another object of the present invention to provide a method and financial arrangement for financing and operating a business project that are capable of improving creditworthiness of the project.

It is yet another object of the present invention to overcome the shortcomings and inherent limitations of the prior art method and financial arrangement for financing and managing a business project.

It is yet another objective of the present invention to provide an attractive financing model and a novel power generation and distribution paradigm to promote efficiency and price competitiveness in the power industry, as originally intended by electricity deregulation.

Other objects will become apparent from the following description.

### SUMMARY OF THE INVENTION

It has now been found that the above-mentioned and related objects of the present invention are obtained in the form of several separate, but related, aspects, including a method, cash trust, and financial instrument for financing and operating a business project, including, for example, power plant projects (e.g., conventional and nuclear power), energy projects (e.g., coal, oil, natural gas), and infrastructure projects (e.g., construction of airports, tunnels, highways, railroads), to name a few. The method, cash trust, and financial instrument of the present invention may also be used to refinance an existing business project in financial distress.

More specifically, the present invention is directed to a method for financing and operating a business project, such as a power plant project, energy project, infrastructure project, etc., with a cash trust, comprising the steps of obtaining funds for financing the business project; allocating at least a portion of the funds in a pre-funded component of the cash trust; maintaining reserves in an operating component of the cash trust; allocating a portion of the reserves for meeting a portion of debt obligation incurred in connection with the step of obtaining funds for financing the business project; and designating at least a portion of a remaining balance of the operating component as financial benefits to be provided to customers of the business project.

The present invention is also directed to a cash trust for financing and operating a business project, such as a power plant project, energy project, infrastructure project, etc., comprising funds for financing the business project; a pre-funded component financed by at least a portion of the funds; and an operating component for maintaining reserves, wherein a portion of the reserves is allocated for meeting a portion of debt obligation incurred in connection with obtaining the funds for financing the business project and at least a portion of remaining balance of the operating component is allocated as financial benefits to be provided to customers of the business project.

Additionally, the present invention is also directed to a financial instrument for financing a business project, such as a power plant project, energy project, infrastructure project, etc., comprising a contractual right to purchase a service or product from the business project; and a contractual right to obtain financial benefits associated with the purchase, wherein the financial benefits vest when the business project meets a predetermined condition such as satisfying a predetermined portion of its debt obligation.

### BRIEF DESCRIPTION OF THE DRAWINGS

The above and related objects, features and advantages of the present invention are more fully understood by reference to the following, detailed description of the preferred, albeit illustrative, embodiment of the present invention when viewed in conjunction with the accompanying figures, wherein:

FIG. 1 illustrates schematically the market structure of the conventional Private Power Model common today in the power generation industry;

FIG. 2 illustrates schematically the market structure of the Public/Private Power Model in accordance with certain embodiments of the present invention as applied to the power generation industry; and

FIG. 3 is an example of the aggregate consumer savings and funding of the operating component of the Cash Trust in units of million dollars, or as a percentage of the total construction costs as a function of time in years, as generated by certain embodiments of the present invention.

### DETAILED DESCRIPTION OF THE INVENTION

The present invention relates generally to a method and financial arrangement for financing and operating a business project. As explained below, the present invention strengthens the credit quality of the business project by appropriately allocating risks inherent in setting up and operating the business project among the appropriate parties, and encouraging prospective consumers and/or end users to invest and/or participate in the project and to remain long-term consumers and/or end users.

In the past, debt service reserve funds were funded up to a predetermined amount (generally an amount equal to six months of debt service). Additionally, construction contingency funds were established to cover construction cost overruns up to a certain amount. The present invention implements a Cash Trust having two components, a pre-funded component and an operating component, which solves many of the problems associated with these prior art methods. Each of these components and their related benefits are described below.

More particularly, the pre-funded component of the Cash Trust is established upon financing of the project, or during construction, and is pre-funded with the proceeds from project financing at a level which enhances the creditworthiness of the project. The pre-funded component of the Cash Trust may be financed by any suitable financial means, including, for example, sales of high-yield bonds, debt, equity, letters of credit, pre-payment by consumers in form of membership fees, or pre-purchase by consumers, to name a few. The size of the pre-funded component of the Cash Trust may be negotiated between lenders and project sponsors, and may be based on various factors such as projected revenues and expenses, potential contingencies, projected market condition, etc.

Unlike the conventional Cash Trap Escrow Account which is intended to be funded during periods of reduced cash flow, the pre-funded component of the Cash Trust provides an immediate and substantive debt service collateral and an available liquid asset that lenders might otherwise exercise remedies over in the event of default by the project. In this regard, even if the project's DSCR falls below a certain minimum level set by lenders, the project may not be required to divert its cash flow into the Cash Trust, provided that funds required by the bank are already set aside in the pre-funded component of the Cash Trust. Thus, the pre-funded component of the Cash Trust enables the project to apply its cash flow in a more productive way to meeting its operational costs while, at the same time, overcoming its financial difficulties. As a result, the pre-funded component of the Cash Trust enhances the project's credit rating and provides a better allocation of the risks among the parties, including consumers and end users of the project.

Similarly, the operating component of the Cash Trust may be funded by any remaining balance in a separate construction contingency fund (or any other existing contingency funds) at the end of the construction phase of the project. Additional funds are added to the operating component of the Cash Trust as a certain percentage of the project's net available cash flow. Funds in the operating component may be added to the pre-funded component (if both components are maintained in a single account) of the Cash Trust, or both the pre-funded and operating components of the Cash Trust may be separate and independent accounts. Further, the Cash Trust may be a regular banking or investment account or a plurality of trust accounts for the benefit of the lenders and individual consumers and/or end users. In one possible embodiment of the present invention, the pre-funded component of the Cash Trust may be phased out when a certain predefined condition is met during the operational phase of the project, such as the remaining debt obligation and/or the balance of the operating component reaching a certain level.

In an embodiment of the present invention, the operating component of the Cash Trust is funded with extra cash flow by eliminating certain inefficiencies typically associated with the project. This extra cash flow may be generated by, for example, membership fees paid by prospective customers, by re-structuring the market and/or financial structure of the project's business model, increasing efficiency, eliminating unnecessary profit centers (i.e., middlemen), and/or other restructuring methods. All or at least a portion of the extra cash flow in the operating component of the Cash Trust will ultimately be provided to consumers and/or end users in the form of a benefit (e.g., financial benefit, social benefit, environmental benefit, etc.). However, in one possible embodiment of the present invention, such benefits are not immediately provided to the project's consumers and/or end users. Rather, at least a portion of the extra cash flow in the operating component of the Cash Trust is applied toward paying off the existing debt, including the debt incurred in funding the pre-funded component of the Cash Trust. This may be done, for example, by redeeming bonds sold to prospective consumers at the outset of the project. While paying off such debt, the business project would charge substantially the same price as its competitors and set aside at least a portion of the extra cash flow in the operating component of the Cash Trust for the future financial, social and/or other benefit of consumers and/or end users. This portion may be invested in income earning accounts in banks or other financial services, or invested in other projects as authorized by the lenders and consumers. This portion may also be used to improve the efficiency of the project to make the project more profitable and/or environment friendly.

After the pre-funded component and/or operating component of the Cash Trust reach a predetermined level, at least a portion of the funds from the operating component of the Cash Trust is returned to the project's consumers and/or end users in the form a benefit. Such benefits may be of a financial nature, including for example, providing a continuing stream of cash rebates which are proportionally based on the consumer's and/or end user's purchase or use of the project's products or services during a predetermined period, or providing further discounts towards future bills, etc. Additionally, these benefits may be provided as social benefits to consumers and/or end users, including for example, funding community projects, environmental projects, or maintenance of parks, etc. The amount of financial or social or environmental benefits could increase with time.

As a result of this arrangement, the host community, project and consumers/end users reap substantial benefits. In this regard, consumers and/or end users are rewarded with financial and social benefits for remaining loyal to the project. The project is rewarded with a loyal and steady consumer base while it pays down its debt. As a result, the likelihood of encountering financial difficulties during the operational phase of the project decreases.

In one embodiment of the present invention, the Cash Trust may be funded by membership fees, or through the issuance of financial instruments (such as stocks, bonds, futures contracts, options contracts, etc.) which may include various contractual rights relating to the project's operation. In particular, these financial instruments may include the following contractual rights: (1) the right to purchase, or receive, a specific amount of product or service from the business project once it commences its operational phase (“the purchase right”); and (2) an accompanying right to receive financial (e.g., rebates) or social benefits corresponding to the purchase of goods or services from the business project (“the benefits right”). These financial instruments may be negotiable instruments, may be freely transferable and can be traded in public. These contractual rights are intended to provide prospective consumers and/or end users of the products or services with an incentive to remain loyal to the project.

It should be noted that the terms and conditions of the purchase right may take various forms. For example, the purchase right may simply confer the right to purchase a specific amount of the product or service from the business project without specifying the price or time of purchase. Alternatively, the purchase right may be similar to the conventional futures contract and is actually a purchase obligation specifying the amount, price and time (or time period) of the purchase. The purchase right may be similar to a conventional option so that the holder of the financial instrument does not have to exercise the purchase right (but then will forsake the future rebates). In another alternative form, the purchase right of the financial instruments may contractually bind the project to pay back the investment with a specific amount of products or services from the business project (i.e., exchange of the investment at the outset of the project with products or services and corresponding rebates from the project when the project becomes operational).

In an embodiment of the present invention, the financial instruments with accompanying purchase and benefits rights, either of one type or in combination of different types, may be bundled together and securitized by financial institutions, like mortgages, and traded in public as, for example, bonds. In yet another embodiment of the present invention, like any financial derivatives, these financial instruments with accompanying purchase and benefits rights may be split into the security component (i.e., underlying bond or stock) and the customer interest component (i.e., accompanying purchase and rebates rights) and each part may be traded separately.

As noted above, the present invention may be used to finance and operate both private or public business projects in a variety of different industries. It is particularly applicable to large, capital-intensive business projects requiring a significant amount of initial capital, in the form of non-recourse or limited recourse debt financing. These projects may include, for example, utility and energy projects (e.g., hydroelectric power, gas power, nuclear power, water, oil, natural gas, gas and electricity transmission), telecommunications projects (e.g., fiber optics network, cellular network, cable network), and large public or private transportation and construction projects (e.g., airports, highways, bridges, tunnels, railroads, subways, housing and office complex).

Similarly, the present invention is applicable not only to financing and operating a new business project, but also to acquiring and re-structuring/refinancing an existing business entity. For example, the present invention may provide a useful new financing model for acquisition and re-vitalization of distressed assets, which were previously financed under the conventional financing arrangements.

An example of the method and financial arrangement of the present invention as applied to various business projects, including financing and operating a power plant, is now described, although it should be understood that the present invention is not intended to be limited to this specific embodiment.

A method and financial arrangement for financing and operating a power plant (including construction of a new power plant and restructuring of an existing power plant) are referred to herein as the “Public/Private Power Model”. As explained below, the Public/Private Power Model addresses, the reluctance of many lenders to finance the high cost of constructing a power plant. The Public/Private Power Model provides an adequate financial security arrangement for lenders without using the conventional Cash Trap Escrow Account. It also, provides financial benefits and incentives to the consumers and/or end users.

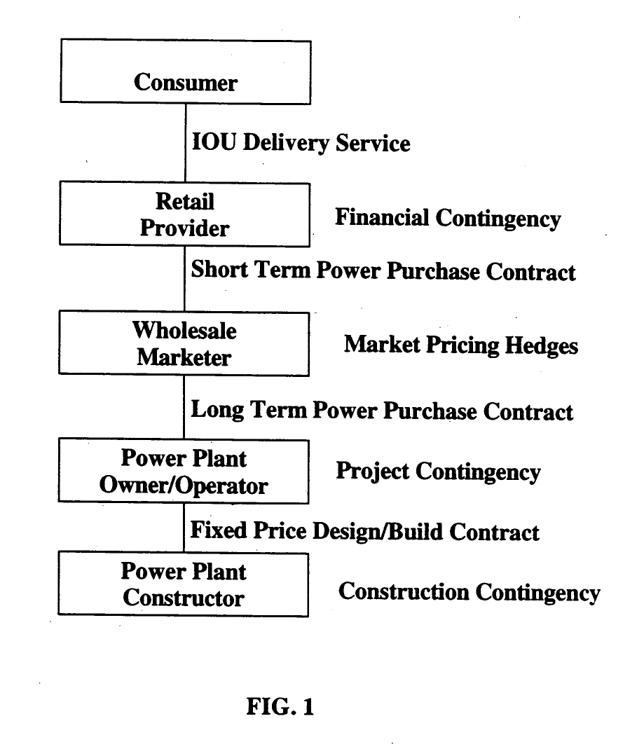

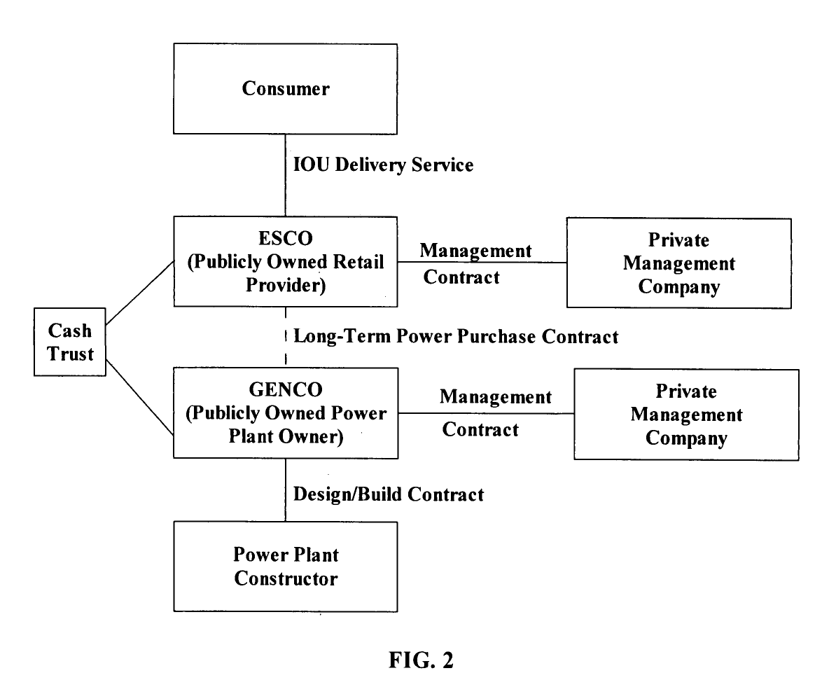

FIG. 2 schematically illustrates the business and market structure of the Public/Private Power Model. Unlike the conventional IPPs which typically generate profits by selling electrical energy to utility companies at wholesale, the power plant operators in the Public/Private Power Model generate profits by selling electrical energy directly to consumers and/or end users at retail prices, charging the consumers and/or end users substantially the same retail price that competing local utilities charge. As shown in FIG. 1, because the business and market structure of the conventional Private Power Model is fragmented into wholesale power markets, retail power markets and transmission and distribution networks (typically monopolized by Investor Owner Utilities or IOUs), the consumers have to pay high utility rates inflated by multiple layers of profit centers, inefficiency, financial hedges and contingencies. By eliminating one or more extra layers of profit center (i.e., a middleman), the power plant project under the Public/Private Power Model creates not only a greater efficiency in generating and distributing power to consumers and/or end users, but also a greater profit margin than would be possible for the power plant project under the conventional Private Power Model, such as IPPs and merchant power plants. As shown below, this extra profit margin may be used to fund an operating component of the Cash Trust.

The present invention is flexible as to how a business project is structured under various relevant government regulations. Under the Public/Private Power Model, one or more publicly owned entities are established to obtain a tax-exempt debt status (i.e., so that they can issue tax-free municipal bonds) and to avoid being subject to the full regulation as a public utility, as shown in FIG. 2.

For example, under current New York City and other state or local regulations, to obtain the benefit of tax-exempt debt status, the energy generating facility (“EGF”) may be owned by a municipal entity (referred to herein as a “Generating Company” or “GENCO”). A GENCO may issue tax-exempt bonds to finance the project. Furthermore, while any private entity owning or operating EGFs would be subject to the regulations under the Public Utility Holding Company Act of 1935 (PUHCA) as a public utility, a GENCO would be exempt from the full force of the PUHCA by being classified as an EWG. A GENCO as an EWG would also be allowed an access to utility transmission lines at reasonable costs.

Since EWGs can sell electrical energy only at wholesale, another municipal entity is necessary to purchase substantially all of the power generated by the GENCO at wholesale and resell that power to retail consumers and/or end users. For example, under the current New York City and other state or local regulations, this second municipal entity is called an “energy service company” (“ESCO”). An ESCO may be affiliated with the GENCO, or may be an completely independent entity. Under the Public/Private Power Model, an ESCO may purchase electrical energy from an GENCO based on a long-term power purchase contract, transmit and distribute that electrical energy over the existing utility transmission network owned by, for example, conventional IOUs, and sell them at retail to residential and/or commercial consumers and/or end users.

The long-term contract between the ESCO and GENCO may be a full requirement contract, requiring the GENCO to provide 100 percent of the electrical energy required by the ESCO, therefore necessitating, when appropriate, the GENCO to purchase power from the spot market if not available from its own EGF, or if economically more beneficial (e.g., at off-peak price). Alternatively, the contract may be a “tolling” arrangement in which the ESCO provides fuels to the GENCO in exchange for electrical energy. The ESCO may also provide a retail fuel service as an ancillary service.

The exemplary power plant project under the Public/Private Power Model may comprise two municipal entities, GENCO and ESCO, which may be affiliated with each other, as shown in FIG. 2. However, under the relevant government regulations, if the EWG status is not necessary and retail sales by an EGF is not precluded, then the ESCO and GENCO may be combined into a single public or private entity.

As shown in FIG. 2, under suitable Qualified Management Agreements in compliance with relevant government regulations, private companies may actually perform power generation and retail sales operations based on a fixed fee basis for the GENCO and ESCO, respectively. The private company conducting power generation operation may manage operations of the EGF and provide various development and maintenance services to the GENCO. The private company conducting retail sales operation may provide marketing, branding, billing and collection services to the ESCO. For example, an existing residential cooperative may assume this role of providing sales services to residential consumers and/or end users. These private companies may also provide financial support to the business project in forms of, for example, subordinated loans, fair market value letters of credit, or cash contributions.

In the Public/Private Power Model, unlike the conventional Private Power Model, the power plant project is provided with a pre-funded component of the Cash Trust upon initial financing of the project and is not required to have the conventional Cash Trap Escrow Account arrangement. In one embodiment of the present invention, the GENCO has access to the pre-funded component of the Cash Trust, while the ESCO has access to the operating component of the Cash Trust. In another embodiment of the present invention, as shown in FIG. 2, both the GENCO and ESCO have joint access to all components of the Cash Trust. In yet another embodiment, the pre-funded component of the Cash Trust may be managed jointly by a board of directors representing the project owners and the GENCO.

In addition to the advantages of the pre-funded component of the Cash Trust described above, the pre-funded component of the present invention also provides liquidity to the power plant project for all kinds of contingencies during construction and operation phases of the project. For example, the pre-funded component of the Cash Trust may be used for construction cost overruns during the construction phase of the project. Once the power plant is in operation, the pre-funded component of the Cash Trust may be used to pay for repairs and replacements, and to provide a buffer for volatility in fuel costs. It may also be used to cover the excess costs arising from the purchase of needed power at the peak price from the spot market during a forced facility shutdown.

The financing arrangement for the power plant project under the Public/Private Power Model may flexibly accommodate various requirements of relevant government regulations as well as requirements of lenders, investors and underwriters. As discussed above, a power plant project in the Public/Private Power Model may be financed, fully or in part, with tax-exempt municipal bonds issued by the municipally owned GENCO. For example, the tax-exempt debt to finance the project may be structured in three tiers. The first-tier bonds may have the characteristics of senior debt with market interest rates and may be used to finance the majority of the capital cost of the project. Second-tier subordinated bonds with market rate coupon of subordinated bonds are used to finance the balance of the capital cost. The third-tier debt includes deeply subordinated bonds, a standby guarantee, or a standby letter of credit may; this tier is used to find the pre-funded component of the Cash Trust.

In addition, a power plant project in the Public/Private Power Model implements an operating component of the Cash Trust which may be funded with a portion of the net cash flow generated from retail power sales as described above and which may also be funded with funds remaining in a construction contingency fund. The operating component of the Cash Trust may be managed by the Owners, GENCO, or the ESCO, or by a third party, or by some combination thereof.

The benefits to be provided by the project's Cash Trust to the consumers may be in the form of customer rebates. The amount of customer rebates may be the difference between the project's total cost of electrical energy production and the retail price for electrical energy as determined by market. A portion of rebates may be immediately provided to consumers and/or end users, while the major portion of the rebates may be accumulated as reserves in the operating component of the Cash Trust. The operating component of the Cash Trust may be managed and the reserves therein may be invested with the express objective of increasing their value over time for the benefit of the consumers and/or end users of the project. Over time, these reserves or some portions thereof may ultimately to be provided to consumers and/or end users. In other words, the operating component of the Cash Trust may effectively become a trust for consumers and/or end users of the project, where the value of an individual rebate correlates directly with the value of the operating component of the Cash Trust.

After the total debt obligations and accumulated reserves in the pre-funded and the operating components of the Cash Trust reaches the certain predetermined level required by the project financing arrangement, all or a substantial portion of the funds from the operating component of the Cash Trust will be returned to consumers and/or end users as rebates or other forms of benefits over time. Accordingly, the Public/Private Power Model provides the power consumers and/or end users effective discounts in their power bills in the form of rebates or other benefits. Furthermore, the Public/Private Power Model provides financial incentives to the consumers and/or end users to remain as long-term consumers and/or end users, as the amount of rebates or other benefits would potentially increase with time as the project debt is paid off.

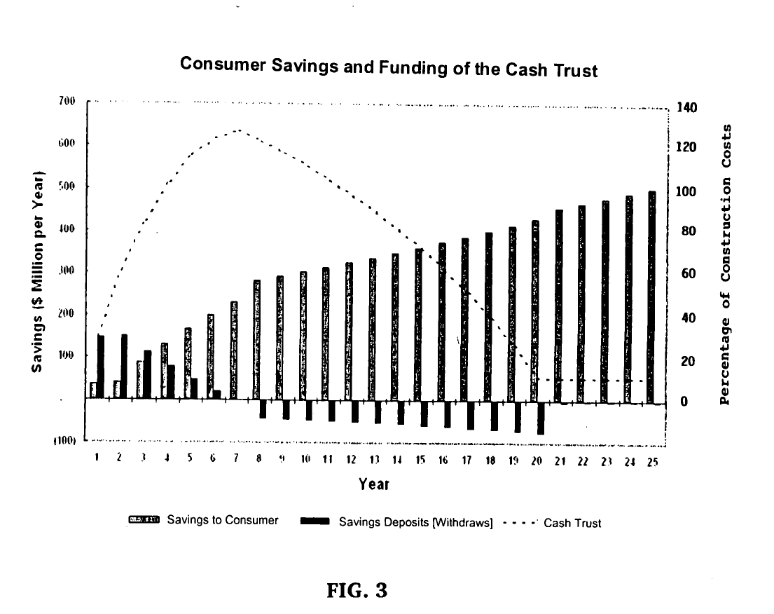

FIG. 3 shows how the amount of aggregate consumer savings rebated to the consumers and/or end users may increase with time according to one simulation spreadsheet calculation based on the Public/Private Power Model, which takes into account projected capital cost (e.g., power plant construction cost, contingency), financing (debt and equity), projected revenue from retail sale of the generated electrical energy with projected rate of return, projected expense (e.g., fuel cost, operation & management cost, insurance), projected inflation rate and interest rate, etc. for a hypothetical model power plant project. In FIG. 3, the “Savings to Consumer” (shown in FIG. 3 as grey bars) represents the portion of these savings that are immediately rebated to the customer. FIG. 3 shows the savings to the consumers after the power plant went into operation, as estimated by the simulation calculation, for each year in units of million dollars (indicated by the left vertical axis) and as a percentage of the total construction costs for the power plant (indicated by the right vertical axis). The “Savings Deposits/Withdrawals” (shown as black bars) represents the remaining balance of the consumer savings, which are initially deposited in the operating component of the Cash Trust and then withdrawn from the operating component of the Cash Trust. Under this particular simulation model, when the balance of the operating component of the Cash Trust equals the predetermined level of debt and reserves required as part of the project financing arrangement, all excess savings begin to be rebated to the consumers. The dotted line in FIG. 3 represents the balance of the operating component of the Cash Trust over the life of the project. The customer's rebated savings become greater as the market price of electrical energy rises over time (due to, e.g., inflation) and as the project debt is paid down and “hedge” requirements for potential contingency are proportionately reduced. After the project debt is completely paid off, the customer's rebated savings may become even greater as all of the money that was assigned to debt service can be now channeled to the customer's rebated savings.

In this embodiment of the present invention, rebates may be designed to favor long-term consumers and/or end users by, for example, taking into account the number of years the customer has purchased electrical energy from the project when calculating each customer's rebates. This would provide additional incentives to the consumers and/or end users to remain as long-term consumers and/or end users.

Under the Public/Private Power Model, a power plant project may be financed by selling various types of financial instruments to the prospective consumers and/or end users of the electrical energy that the power plant will eventually generate. One such financial instrument may be a bond in small denomination (e.g., $1,000) accompanied by a transferable right to purchase at then retail market price or some discounted price, or, alternatively, receive at no charge (i.e., essentially pre-payment for future purchase of power), a specific amount of power (e.g., 1,000 kilowatts of electricity) from the project's power plant once it becomes operational. In addition, the bondholder is entitled to the rebates associated with the purchase of the power. For example, a holder of this financial instrument, who is also a prospective residential customer, may purchase or receive the designated amount of power and associated rebates from the project, once the power plant becomes operational. If, before consuming the designated amount of power, the instrument holder decides to sell the house and move away from the project's service area, he or she may sell the financial instrument and its accompanying right to purchase the remaining amount of power and the associated rebates to someone else in the service area.

To encourage bond purchase, bondholders may be given a special priority when rebates are distributed by the project. Potential purchasers of this type of financial instrument may include, for example, urban housing or apartment cooperatives, apartment owners, office complex owners and other prospective commercial consumers and/or end users (such as factories, shopping malls, etc.) who have been facing escalating electricity costs and would therefore greatly benefit from the financial benefits and incentives provided by the operating component of the Cash Trust in the form of, for example, rebates.

In this embodiment, the financial instrument may be split into a security component (e.g., interest-bearing bond or equity) and customer interest component (i.e., the right to purchase or receive a set amount of power and the right to receive the associated rebates) and the holder of the financial instrument may freely transfer each component separately. Each component may be traded in public with market value of its own and may be further securitized by financial institutions into other forms of financial instruments.

In the above illustrative example, the pre-funded component of the Cash Trust provides project's lenders with adequate financial security and debt service collateral while, at the same time, provides the project's sponsors and operators with a buffer in the event of unexpected contingency. Furthermore, this arrangement eliminates the need for the conventional Cash Trap Escrow Account arrangement, although the present invention does not require complete exclusion of such Cash Trap Escrow Account. Consumers and/or end users clearly benefit from lower power rates by receiving rebates on power used and are given an opportunity to participate in the project by obtaining a transferable right to purchase the electrical energy, along with the entitlement to the associated benefits. By better allocating the risks, the Public/Private Power Model provides a cooperative solution to overcome the current disarray in the power industry.

Now that the preferred embodiments of the present invention have been shown and described in detail, various modifications and improvements thereon will become readily apparent to those skilled in the art. Accordingly, the spirit and scope of the present invention is to be construed broadly and limited only by the appended claims and not by the foregoing specification.

What is claimed is:

1. A method for financing and operating a power plant project with a cash trust comprising the steps of:
obtaining funds for financing said power plant project;
allocating at least a portion of said funds in a pre-funded component of said cash trust;
maintaining reserves in an operating component of said cash trust;
allocating a portion of said reserves for meeting a portion of debt obligation incurred in connection with said step of obtaining funds for financing said power plant project; and
designating at least a portion of a remaining balance of said operating component as financial benefits to be provided to customers of said power plant project.

2. The method of claim 1, further comprising the step of financing said pre-funded component during initial financing stage of said power plant project.

3. The method of claim 1, wherein said reserves comprise at least a portion of net cash flow generated by said power plant project.

4. The method of claim 1, further comprising the step of issuing at least one financial instruments which comprises a contractual right to a purchase a designated amount of electrical energy from said power plant project and a contractual right to obtain said financial benefits associated with said purchase.

5. The method of claim 4, wherein said financial instrument further comprises a bond.

6. The method of claim 4, wherein said financial instrument is transferable.

7. The method of claim 4, wherein said financial benefits are rebates.

8. The method of claim 1, wherein said pre-funded component is financed with debt.

9. The method of claim 8, wherein said debt comprises proceeds from sale of bonds.

10. The method of claim 1, further comprising the step of maintaining said pre-funded component separately from said funds for financing said power plant project.

11. The method of claim 1, wherein said step of allocating a portion of said reserves for meeting a portion of debt obligation is only performed until a balance of said reserves in said reserve account and said debt obligation reaches a predetermined level.

12. The method of claim 1, wherein said financial benefits are rebates.

13. The method of claim 1, wherein said step of maintaining at least a portion of remaining balance comprises the step of investing said at least a portion of remaining balance.

14. The method of claim 1, wherein said power plant project comprises operation of a natural-gas based combustion power plant.

15. The method of claim 1, wherein said power plant project comprises operation of a nuclear power plant.

16. The method of claim 5, wherein said bond is a non-recourse tax-exempt municipal bond.

17. The method of claim 1, wherein said power plant project involves a new power plant.

18. The method of claim 1, wherein said power plant project involves an existing power plant.

19. The method of claim 18, wherein said existing power plant is financially distressed and is refinanced in accordance with said method.

20. The method of claim 1, wherein said step of obtaining funds for financing comprises the step of issuing financial instruments, wherein each of said financial instruments comprises a contractual right to receive a designated amount of electrical energy from said power plant project in exchange for an investment in said power plant project and a contractual right to obtain said financial benefits associated with said designated amount of electrical energy.

21. A cash trust for financing and operating a power plant project comprising:
funds for financing said power plant project;
a pre-funded component financed by at least a portion of said funds; and
an operating component for maintaining reserves, wherein a portion of said reserves is allocated for meeting a portion of debt obligation incurred in connection with obtaining said funds for financing said power plant project and at least a portion of a remaining balance of said operating component is allocated as financial benefits to be provided to customers of said power plant project.

22. The cash trust of claim 21, wherein said pre-funded component is financed during initial financing stage of said power plant project.

23. The cash trust of claim 21, wherein said reserves comprise at least a portion of net cash flow generated by said power plant project.

24. The cash trust of claim 21, wherein said funds comprise proceeds from issuance of at least one financial instrument which comprises a contractual right to purchase a designated amount of power from said power plant project and a contractual right to obtain said financial benefits associated with said purchase.

25. The cash trust of claim 24, wherein said financial instrument further comprises a bond.

26. The cash trust of claim 24, wherein said financial instrument is transferable.

27. The cash trust of claim 24, wherein said financial benefits are rebates.

28. The cash trust of claim 21, wherein said pre-funded component is financed with debt.

29. The cash trust of claim 28, wherein said debt comprises proceeds from sale of bonds.

30. The cash trust of claim 21, wherein said pre-funded component is maintained separately from said funds for financing said power plant project.

31. The cash trust of claim 21, wherein a portion of said reserves is allocated for meeting at least a portion of said debt obligation until a balance of said reserves in said operating component and said debt obligation reaches a predetermined level.

32. The cash trust of claim 21, wherein said financial benefits are rebates.

33. The cash trust of claim 21, wherein said at least a portion of remaining balance of said operating component is invested.

34. The cash trust of claim 21, wherein said power plant project comprises operation of a natural-gas based combustion power plant.

35. The cash trust of claim 21, wherein said power plant project comprises operation of a nuclear power plant.

36. The cash trust of claim 25, wherein said bond is a non-recourse tax-exempt municipal bond.

37. The cash trust of claim 21, wherein said power plant project involves a new power plant.

38. The cash trust of claim 21, wherein said power plant project involves an existing power plant.

39. The cash trust of claim 38, wherein said existing power plant is financially distressed and is refinanced in accordance with said financing arrangement.

40. The cash trust of claim 21, wherein said funds comprise proceeds from issuance of financial instruments, wherein each of said financial instruments comprises a contractual right to receive a designated amount of electrical energy from said power plant project in exchange for an investment in said power plant project and a contractual right to obtain said financial benefits associated with said designated amount of electrical energy.

41. A financial instrument for financing a power plant project comprising:
a contractual right to purchase a designated amount of electrical energy from said power plant project; and
a contractual right to obtain financial benefits associated with said designated amount of electrical energy from said power plant project, wherein said financial benefits vest when said power plant project satisfies a predetermined portion of its debt obligation.

42. The financial instrument of claim 41, wherein said financial benefits are provided from a cash trust maintained by said power plant project and said cash trust comprises a pre-funded component and an operating component.

43. The financial instrument of claim 42, wherein said operating component is financed by at least a portion of cash flow generated by said power plant.

44. The financial instrument of claim 42, wherein said pre-funded component is financed during initial financing stage of said power plant project.

45. The financial instrument of claim 41, wherein at least one of said contractual right to purchase and said contractual right to obtain financial benefits is transferable.

46. The financial instrument of claim 41, further comprising a security.

47. The financial instrument of claim 46, wherein said security is a bond.

48. The financial instrument of claim 41, wherein said financial benefits are rebates.

49. A method for financing and operating a business project with a cash trust, comprising the steps of:
obtaining funds for financing said business project;
allocating at least a portion of said funds in a pre-funded component of said cash trust;
maintaining reserves in an operating component of said cash trust;
allocating a portion of said reserves for meeting a portion of debt obligation incurred in connection with said step of obtaining funds for financing said business project; and
designating at least a portion of a remaining balance of said operating component as financial benefits to be provided to customers of said business project.

50. The method of claim 49, further comprising the step of financing said pre-funded component during initial financing stage of said power plant project.

51. The method of claim 49, wherein said reserves comprise at least a portion of net cash flow generated by said business project.

52. The method of claim 49, further comprising the step of issuing at least one financial instrument which comprises a contractual right to purchase from said business project and a contractual right to obtain said financial benefits associated with said purchase.

53. The method of claim 52, wherein said financial instrument further comprises a bond.

54. The method of claim 52, wherein said financial instrument is transferable.

55. The method of claim 52, wherein said financial benefits are rebates.

56. The method of claim 49, wherein said pre-funded component is financed with debt.

57. The method of claim 56, wherein said debt comprises proceeds from sale of bonds.

58. The method of claim 49, further comprising the step of maintaining said pre-funded component separately from said funds for financing said business project.

59. The method of claim 49, wherein said step of allocating a portion of said reserves for meeting a portion of debt obligation is only performed until a balance of said reserves in said operating component and said debt obligation reaches a predetermined level.

60. The method of claim 49, wherein said financial benefits are rebates.

61. The method of claim 49, wherein said step of maintaining at least a portion of remaining balance comprises the step of investing said at least a portion of remaining balance.

62. The method of claim 53, wherein said bond is a non-recourse tax-exempt municipal bond.

63. The method of claim 49, wherein said business project involves a new business.

64. The method of claim 49, wherein said business project involves an existing business.

65. The method of claim 64, wherein said existing business is financially distressed and is refinanced in accordance with said method.

66. A cash trust for financing and operating a business project comprising:
funds for financing said business project;
a pre-funded component financed by at least a portion of said funds; and
an operating component for maintaining reserves, wherein a portion of said reserves is allocated for meeting a portion of debt obligation incurred in connection with obtaining said funds for financing said business project and at least a portion of remaining balance of said operating component is allocated as financial benefits to be provided to customers of said business project.

67. The cash trust of claim 66, wherein said pre-funded component is financed during initial financing stage of said business project.

68. The cash trust of claim 66, wherein said reserves comprise at least a portion of net cash flow generated by said business project.

69. The cash trust of claim 66, wherein said funds comprise proceeds from issuance of at least one financial instrument which comprises a contractual right to purchase from said business project and a contractual right to obtain said financial benefits associated with said purchase.

70. The cash trust of claim 69, wherein said financial instrument further comprises a bond.

71. The cash trust of claim 69, wherein said financial instrument is transferable.

72. The cash trust of claim 69, wherein said financial benefits are rebates.

73. The cash trust of claim 66, wherein said pre-funded component is financed with debt.

74. The cash trust of claim 73, wherein said debt comprises proceeds from sale of bonds.

75. The cash trust of claim 66, wherein said pre-funded component is maintained separately from said funds for financing said business project.

76. The cash trust of claim 66, wherein said portion of said reserves is allocated for meeting said portion of said debt obligation until a balance of said reserves in said operating component and said debt obligation reaches a predetermined level.

77. The cash trust of claim 66, wherein said financial benefits are rebates.

78. The cash trust of claim 66, wherein said at least a portion of remaining balance of said operating component is invested.

79. The cash trust of claim 70, wherein said bond is a non-recourse tax-exempt municipal bond.

80. The cash trust of claim 66, wherein said business project involves a new business.

81. The cash trust of claim 66, wherein said business project involves an existing business.

82. The cash trust of claim 81, wherein said existing business is financially distressed and is refinanced in accordance with said method.

83. A financial instrument for financing a business project comprising:
a contractual right to purchase a service or product from said business project; and
a contractual right to obtain financial benefits associated with said purchase, wherein said financial benefits vest when said business project satisfies a predetermined portion of its debt obligation.

84. The financial instrument of claim 83, wherein said financial benefits are provided from a cash trust maintained by said business project and said cash trust comprises a pre-funded component and an operating component.

85. The financial instrument of claim 84, wherein said operating component is financed by at least a portion of cash flow generated by said business project.

86. The financial instrument of claim 84, wherein said pre-funded component is financed during initial financing stage of said business project.

87. The financial instrument of claim 83, wherein at least one of said contractual right to purchase and said contractual right to obtain financial benefits is transferable.

88. The financial instrument of claim 83, further comprising a security.

89. The financial instrument of claim 88, wherein said security is a bond.

90. The financial instrument of claim 83, wherein said financial benefits are rebates.

91. The method of claim 1, wherein said pre-funded component is phased out during operational stage of said power plant project.

92. The cash trust of claim 21, wherein said pre-funded component is phased out during operational stage of said power plant project.

93. The financial instrument of claim 42, wherein said pre-funded component is phased out during operational stage of said power plant project.

94. The method of claim 49, wherein said pre-funded component is phased out during operational stage of said business project.

95. The cash trust of claim 66, wherein said pre-funded component is phased out during operational stage of said business project.

96. The financial instrument of claim 84, wherein said pre-funded component is phased out during operational stage of said business project.

97. The method of claim 1, wherein said cash trust further comprises a cash trap escrow account.

98. The cash trust of claim 21, wherein said cash trust further comprises a cash trap escrow account.

99. The financial instrument of claim 42, wherein said cash trust further comprises a cash trap escrow account.

100. The method of claim 49, wherein said cash trust further comprises a cash trap escrow account.

101. The cash trust of claim 66, wherein said cash trust further comprises a cash trap escrow account.

102. The financial instrument of claim 84, wherein said cash trust further comprises a cash trap escrow account.
